(19) United States
(12) Patent Application Publication
(10) Pub. No.: US 2024/0170787 A1
(43) Pub. Date: May 23, 2024

(54) BATTERY ARRANGEMENT

(71) Applicant: AUDI AG, Ingolstadt (DE)

(72) Inventors: Johann BERGER, Reischach (DE); Markus THURMEIER, Adlkofen (DE)

(73) Assignee: AUDI AG, Ingolstadt (DE)

(21) Appl. No.: 18/502,367

(22) Filed: Nov. 6, 2023

(30) Foreign Application Priority Data
Nov. 18, 2022 (DE) 102022130550.3

(51) Int. Cl. H01M 50/249; H01M 50/264

(52) U.S. Cl. CPC H01M 50/249; H01M 50/264; H01M 2220/20

(57) ABSTRACT

A battery arrangement in a vehicle including at least two body supports of the vehicle, between which there is a receiving space, at least one battery, which is arranged at least in some areas in the receiving space between the body supports. At least on one side of the battery there is a distance between a body support and a boundary surface of the battery, and at least one fixing element which bridges or fills the distance in an installed state and is transferable to a mounting state in which the fixing element does not or only partially bridges or fills the distance.

### FIELD

The invention relates to a battery arrangement in a vehicle comprising at least two body supports of the vehicle, between which there is a receiving space, at least one battery, which is arranged at least in some areas in the receiving space between the body supports, wherein at least on one side of the battery there is a distance between a body support and a boundary surface of the battery, and at least one fixing element which bridges or fills the distance in an installed state and is transferable to a mounting state in which the fixing element does not or only partially bridges or fills the distance. The invention furthermore relates to a vehicle having a battery arrangement and a method for mounting a battery in a vehicle.

### BACKGROUND

Batteries which have a high weight are often required in vehicles. Such batteries can be, for example, drive batteries of an electrically powered vehicle or a hybrid vehicle. Due to their large size and high weight, batteries are preferably arranged in the lower area of the vehicle in order to achieve a low overall center of gravity of the vehicle. For example, a battery can be placed between two body supports, in particular between two rocker panels, in the vehicle. In order to be able to mount the battery between two body supports and, if necessary, also dismount it, clearance in the form of a distance is required to allow the battery to move between the body supports. However, this clearance required for mounting has disadvantages in the event of an accident of the vehicle. A load that acts on the vehicle in the event of an accident cannot be passed on from the body supports to the battery and vice versa via the distance or clearance. The load or energy that acts in the event of an accident is therefore passed on to other paths and can result there in deformation and damage. In addition, in the event of an accident, inertia forces acting on the battery cannot be passed on to supporting parts of the vehicle, or can only be transferred with difficulty.

DE 10 2012 001 596 A1 describes an energy-absorbing protective element which is arranged between the vehicle body and the battery. The protective element is fillable by a medium, in particular compressed air, and absorbs load or energy in the event of an accident.

DE 10 2014 112 741 A1 describes a motor vehicle having a battery installed in the underbody. In this motor vehicle, a compressed air storage element is arranged along the long sides between the battery and adjacent body supports. The compressed air storage element is used to protect the battery in the event of a side impact.

DE 10 2018 218 789 A1 describes a vehicle having a battery arranged between two body side members. A coupling element is arranged between the battery and each of the body side members, the shape of which is unchangeable and adapted to the shape of the battery and the body of the vehicle.

### SUMMARY

The object of the invention is to propose solutions by which accident safety in vehicles having a battery can be improved and the mounting and dismounting of the battery in the vehicle is simplified.

This object of the invention is achieved by a battery arrangement in a vehicle comprising
at least two body supports of the vehicle, between which there is a receiving space,
at least one battery which is arranged at least in some areas in the receiving space between the body supports, wherein at least on one side of the battery there is a distance between a body support and a boundary surface of the battery,
at least one fixing element, which bridges or fills the distance in an installed state and is transferable into a mounted state in which the fixing element does not or only partially bridges or fills the distance, wherein the fixing element is formed rigid at least in some areas.

The battery arrangement according to the invention is used to securely fasten a battery in a vehicle. The vehicle can be, for example, a motor vehicle, such as an automobile. However, the battery arrangement can also be arranged in another vehicle, for example in a trailer or wagon. The battery arrangement comprises at least two body supports of the vehicle and a receiving space arranged between them. The body supports are supporting structures of the vehicle. The body supports can be formed, for example, by rocker panels of an automobile. A receiving space arranged between these body supports is the location at which a battery is arranged. This receiving space is preferably located in the lower area or in the underbody of the vehicle. In the mounted state, the battery only fills part of the receiving space. On at least one side of the battery there is a distance in the receiving space between a body support and a boundary surface or outer surface of the battery. Preferably, a distance between the battery and the respective adjacent body support is arranged on two opposite sides of the battery in order to enable easy mounting and dismounting of the battery in the receiving space. A battery is to be understood as an assembly which has an electrical energy storage device which is arranged in a housing. The battery is usually connected and fastened in the receiving space via portions of the housing of the battery. In the following, the assembly having the electrical energy storage device and the associated housing is simply referred to as a battery. Distance is to be understood as both a dimension which extends in the free space between a body support and a boundary surface of the battery and the cavity which is arranged between the battery and the body support. The dimension of the distance preferably extends between a portion of the battery and a portion of a body support arranged parallel thereto. The dimension of the distance can also be used as a direction indication, wherein the direction of the distance is preferably oriented perpendicular to the direction of travel of the vehicle. For other applications, the direction of the distance can also be oriented parallel to the direction of travel. The cavity defined by the distance is usually only filled with air, unless a fixing element has already been inserted into the distance. According to the invention, the battery arrangement comprises at least one fixing element, which can assume two states: an installed state, which is set when the battery arrangement is assembled, and a mounting state in which the battery can be inserted into or removed from the receiving space. The fixing element is a geometric, physical element which has at least one variable dimension in order to enable a transfer from the installed state to the mounting state and vice versa. In the installed state, the fixing element bridges the distance completely or fills it completely. In this way, in the installed state, there is a closed load path between the body support and the battery. This closed load path is created by a form-fitting connection between these elements and enables the passing on of load or energy that acts on its assemblies in the event of a collision or other accident of the vehicle. By way of this load path provided by the fixing element, the two body supports, which are preferably arranged parallel to one another, are connected to one another by the battery arranged between them. In the mounting state of the fixing element, part of the distance or cavity remains between the battery and an adjacent body support, since the fixing element does not or only partially bridges or fills the distance. In the mounting state, there is therefore clearance to mount or dismount the battery in the receiving space. According to the invention, the fixing element is designed to be rigid at least in some areas. Rigid means that the fixing element is essentially non-deformable. This rigid design ensures that compressive forces are efficiently passed on via the fixing element between the body support and the battery. Due to the rigid design, the fixing element passes on load and energy directly without absorbing or damping the load or energy by deformation. The fixing element can be designed as completely rigid or can have two or more rigid portions which are designed to be movable relative to one another and adjustable in their position and are then fixable in position relative to one another.

Due to the battery arrangement according to the invention, the battery in a vehicle is mechanically coupled to two body supports, thereby providing a load path which enables load and energy to be passed on in the vehicle in the event of an accident. In this way, the accident safety of the vehicle is improved and damage to the body and battery is reduced. At the same time, the fixing element, which can be changed in size, shape, or position, enables simple and quick mounting and dismountingy of the battery in the receiving space. The battery arrangement is suitable for vehicles in which the battery remains in the vehicle for a long time as well as for vehicles in which the battery is replaced regularly. Such regular replacement of the battery can be used, for example, in battery replacement systems to increase the range of an electrically driven vehicle in a very short time by simply replacing the battery.

In one embodiment it is provided that the body supports extend essentially in the direction of travel of the vehicle, in particular are designed as rocker panels, and the distance is in a direction perpendicular to the direction of travel of the vehicle in the receiving space between a body support and the battery, wherein in the mounting state of the fixing element at least a portion of the distance remains to enable mounting or dismounting of the battery in the receiving space. In this embodiment, the distance is arranged in a direction perpendicular to the direction of travel of the vehicle between a body support and the battery and also extends in this direction. The introduced or bridging fixing element is therefore part of a load path along which loads can be passed on to the vehicle in the event of a side impact. Alternatively, the distance can also extend in a different, horizontally oriented direction, for example in the direction of travel.

In a further embodiment it is provided that the fixing element is designed to be completely rigid and is movably connected to a body support, wherein in the installed state the fixing element bridges the distance and abuts the battery or is connected in a form-fitting manner to a portion of the battery and in the mounting state the fixing element is disconnected from the battery. The fixing element can consist of a single, rigid part. In this embodiment, the fixing element is producible inexpensively and is robust.

Furthermore, it can be provided that the fixing element is rotatably or/or linearly displaceably fastened on the fixing element and is transferable from the installed state to the mounting state and vice versa by a rotational movement and/or a translational movement. This embodiment concerns a completely rigid fixing element. The fixing element is movably attached to a body support and can be transferred from the installed state to the mounting state by a simple rotational movement or displacement movement. In addition, the fixing element is fixable in its position at least in the installed state. It is particularly advantageous to connect the fixing element to the body support via a joint. During the transfer from the installed state to the mounting state and vice versa, the fixing element and the joint axis, which is preferably arranged horizontally, are rotated. The fixing element can be designed in the form of a bracket or hook, which bridges the entire distance in the installed state and is folded away from the battery in the mounting state in order to enable easy mounting and dismounting.

In an alternative embodiment it is provided that the fixing element comprises a body element which abuts the body support in the installed state and a battery element which abuts the battery, wherein the body element and the battery element are each designed to be rigid at least in some areas, wherein the relative position of the battery element to the body element and thus an external dimension of the fixing element extending in the installed state between the body support and the battery is adjustable via an adjustment mechanism which connects the battery element to the body element, wherein the fixing element is arranged at least in some areas in the receiving space in the installed state and fills the distance and does not or only partially fills the distance in the mounting state and the external dimension essentially corresponds to the distance in the installed state and is less than the distance in the mounting state. In this embodiment, the fixing element comprises two rigid elements that are movable relative to one another: a body element and a battery element. Both elements are connected to one another by an adjustment mechanism, which enables the adjustment of an external dimension, which extends in the direction of the distance in the installed state. The adjustment mechanism allows the relative position of the two elements to be adjusted to one another in such a way that the fixing element either completely fills the distance or the external dimension is smaller than the distance and thus there is clearance for movement of the battery in the receiving space in the mounting state.

In one embodiment it is provided that the body element and the battery element are each wedge-shaped in some areas, wherein the wedge-shaped areas are oriented inclined to the distance and the adjustment mechanism has a tension element acting perpendicular to the distance, which pulls the body element and the battery element toward one another in a direction perpendicular to the distance when actuated and when the tension element is actuated, the wedge-shaped areas of the body element and battery element slide on one another and thereby translate the relative movement of the body element and battery element perpendicular to the distance towards one another into a relative movement of the body element and battery element in the direction of the distance away from one another, and the external dimension enlarges. In this embodiment, a wedge shape of the body element and battery element is used to translate a movement generated by the adjustment mechanism in a direction perpendicular to the distance into a change of the external dimension of the fixing element in the direction of the distance. The adjustment mechanism has a simple structure and comprises a tension element, which can be designed, for example, as a threaded bolt having a wing nut. When the adjustment mechanism is actuated, the body element and battery element are moved towards one another in the direction of the longitudinal axis of the tension element. The inclined surfaces on the elements slide on one another and thus translate the applied movement into a relative movement of the two elements away from one another in the direction of the distance. To transfer it to the installed state, the adjustment mechanism is actuated until the external dimension corresponds to the distance and the fixing element thus completely fills the distance. Alternatively to a two-part fixing element, in which both parts comprise a wedge-shaped area, a wedge-shaped portion can also be provided firmly connected to the body support or the battery, which cooperates with a wedge-shaped element of the fixing element.

In a further embodiment it is provided that the body element and the battery element are arranged adjacent to one another in some areas in the direction of the distance, wherein the adjustment mechanism comprises a variable-size chamber arranged between the body element and the battery element, which is fillable with a medium and an enlargement of the chamber by filling with the medium causes an enlargement of the external dimension in that the chamber pushes the body element and the battery element apart in the direction of the distance and in the installed state there is more medium in the chamber than in the mounting state. In this embodiment, two rigid elements of the fixing element are provided, which are arranged adjacent to one another in some areas and, on the other hand, overlap or penetrate into one another in some areas. The adjustment mechanism comprises a variable-size chamber, which is sealed to the outside and can be filled with a medium, such as oil or air. A change of the external dimension is achieved by introducing medium into this chamber or removing medium therefrom. The external dimension can therefore be continuously adjusted by the amount of medium contained in the chamber. In this embodiment, the fixing element can be formed, for example, by a hydraulic or pneumatic cylinder, which is arranged having its direction of action parallel to the distance.

Alternatively, it is possible for the body element and the battery element to be arranged adjacent to one another in some areas in the direction of the distance, wherein the adjustment mechanism comprises a linear drive arranged between the body element and the battery element and an actuation of the linear drive changes the relative position of the body element and the battery element to one another and thus the external dimension, wherein the linear drive comprises an electric motor or a manually operable drive. In this embodiment as well, the fixing element comprises two rigid elements, which are arranged adjacent to one another in some areas. The adjustment mechanism comprises a mechanically acting linear drive, by which the external dimension of the fixing element is adjustable. For example, this linear drive can comprise a toothed rack and a gear connected thereto, wherein the toothed rack is moved translationally in the direction of the distance when the gear rotates. The linear drive can comprise an electric motor or a manually operable drive. The linear drive is additionally designed to be fixable or lockable, at least in the installed state.

The object of the invention is furthermore achieved by a vehicle having a battery arrangement according to one of the previously described embodiments, wherein the distance between at least one body support and the battery is preferably oriented perpendicular to the direction of travel of the vehicle. The vehicle according to the invention having a battery arrangement has significantly increased accident safety, since the battery arrangement provides a load path for passing on loads and energies arising in the event of an accident. In the installed state, loads are passed on through the battery arrangement in the event of an accident, thus reducing or avoiding deformations on the components of the battery arrangement. In addition, in the mounting state, it is possible to easily install, remove, or replace the battery in the vehicle.

The object of the invention is finally achieved by a method for mounting a battery in a vehicle, wherein a battery arrangement according to one of the previously described embodiments is used to carry out the method, comprising the following method steps
A) transferring the at least one fixing element into the mounting state,
B) introducing the battery into the receiving space between two body supports of the vehicle, wherein the distance between the battery and at least one body support is used as clearance during the introduction,
C) transferring the fixing element into the installed state, in which the fixing element bridges or fills the distance, by which the battery is fixed in the receiving space in a form-fitting and/or force-fitting manner between the body supports.

The method according to the invention is used to mount or install a battery in a vehicle. The method is preferably carried out in the specified sequence of method steps A) to C). The method can be carried out in reverse sequence to dismount a battery in a vehicle or remove it from the vehicle. To replace a battery in a vehicle, the method can first be carried out in reverse sequence of method steps C) to A) for removal and then in the sequence of method steps A) to C) for installation of the battery.

In a first method step A), at least one fixing element is transferred to the mounting state in which it does not fill or bridge the entire distance.

In a second method step B), the battery is now introduced into the receiving space. The distance is used as clearance so that the battery can be introduced into the receiving space without damage.

Finally, in a third method step, the fixing element is transferred to the installed state, by which a continuous load path is provided between the body support and the battery. The method according to the invention is easy to carry out using the battery arrangement, so that the battery can be mounted quickly and safely in the receiving space. After carrying out the method, the vehicle having the battery has increased accident safety because the battery is fixed in the receiving space in a form-fitting and/or force-fitting manner.

Features, effects, and advantages that are disclosed in connection with the battery arrangement and the vehicle are also considered to be disclosed in connection with the method. This also applies in the reverse direction, features, effects, and advantages that are disclosed in connection with the method are also considered to be disclosed in connection with the battery arrangement and the vehicle.

### BRIEF DESCRIPTION OF THE FIGURES

The invention is schematically illustrated in the drawings with the aid of embodiments and is described further with reference to the drawings. In the figures:

FIG. 1 shows a schematic view of a possible embodiment of a battery arrangement according to the invention,

FIG. 2 shows a schematic view of an alternative embodiment of a battery arrangement according to the invention,

### DETAILED DESCRIPTION

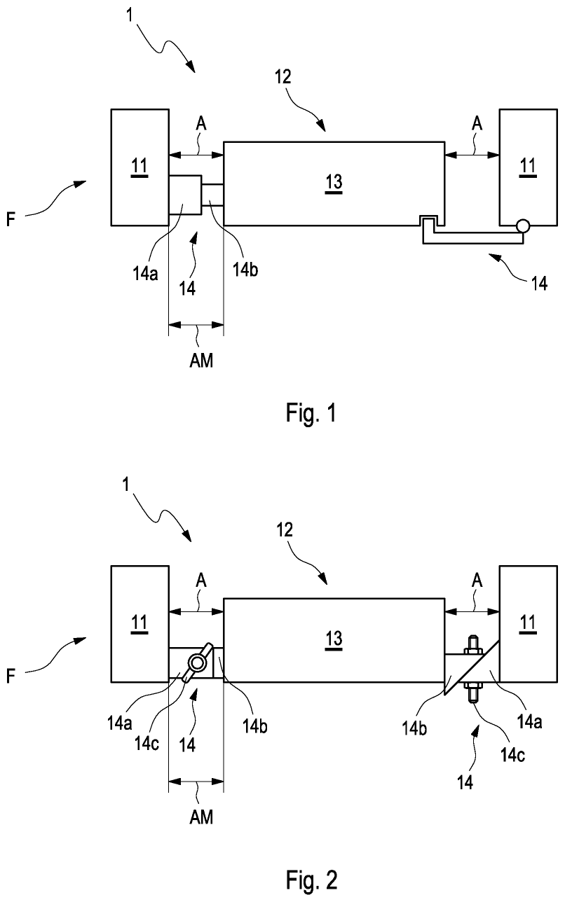

FIG. 1 shows a schematic view of a possible embodiment of a battery arrangement 1 according to the invention, In FIG. 1, a battery arrangement 1 can be seen viewed in the direction of travel of a vehicle F. In the middle there is a battery 13, which comprises battery cells housed in a battery housing. Details of the battery housing and the individual battery cells are not shown. On the outer left and on the outer right edge there is in each case a body support 11 of the vehicle F, which here extends in the direction of travel, that is, into the plane of the drawing and out of the plane of the drawing. Between the two body supports 11 there is a receiving space 12 in which the battery 13 is housed. Due to the high weight of the battery 13, the battery arrangement 1 is preferably arranged in the underbody of the vehicle F, wherein the two body supports 11 are preferably formed by rocker panels. There is a distance A between the battery 13 and each of the two body supports 11. In the mounting state, this distance A is used to allow sufficient clearance for the mounting and dismounting of the battery 13 in the receiving space 12. In the embodiment shown, the distance A extends perpendicular to the direction of travel of the vehicle F. In FIG. 1, the installed state of the battery arrangement 1 is shown, in which a fixing element 14 is attached in or adjacent to each of the two distances A. The fixing element 14 forms in each case a bridge for passing on load or energy in the event of an accident of the vehicle F between a body support 11 and the battery 13 over the distance A. In order to enable safe and reliable passing on of load and energy, the fixing element 14 is designed to be rigid at least in some areas and is therefore very suitable for passing on compressive forces. In FIG. 1, differently designed fixing elements 14 are arranged in or at each of the two distances A. In this way, two different embodiments of fixing elements 14 can be described using one figure. However, if there are two distances A, fixing elements 14 of the same design are preferably used to connect the battery 13 and body supports 11 in the receiving space 12. On the right side a completely rigid fixing element 14 is visible, which bridges the right distance A. This fixing element 14 is rotatably connected to the right body support 11 via a joint. The left-facing end of the fixing element 14 is partially inserted into an undercut in the battery 13, by which the battery 13 and the fixing element 14 are connected to one another in a form-fitting manner in the installed state shown. In order to transfer the fixing element 14 into the mounting state, the form fit between the battery 13 and the fixing element 14 can be canceled and the fixing element 14 can be folded down around the joint in a rotational movement. In this folded-down state, the fixing element 14 no longer bridges the distance A and thus enables the battery 13 to be mounted or dismounted in the receiving space 12. In the embodiment shown, the right fixing element 14 is designed as a hook or claw. The fixing element 14 can be transferred from the installed state to the mounting state and vice versa either by hand or by an automatic mechanism.

In the left distance A in FIG. 1, a fixing element 14 is arranged, which comprises two rigid sections which are connected to one another in a movable or shape-changing manner. This fixing element 14 includes a body element 14a abutting the body support 11 and a battery element 14b abutting the battery 13. Furthermore, the fixing element 14 comprises an adjustment mechanism 14c (not shown) arranged in the interior, which enables the relative position of the body element 14a to the battery element 14b to be adjusted. The fixing element 14 has an external dimension AM, which extends in the direction of the distance A in the installed state shown. In the installed state shown, the fixing element 14 fills the left distance A. The adjustment mechanism 14c in the interior comprises a variable-size chamber which is filled with medium. If the chamber is filled with more of this medium, it enlarges and thus presses the body element 14a and the battery element 14b apart, so that the external dimension AM enlarges. If, on the other hand, medium is removed from the chamber, it becomes smaller, which in turn results in a reduction in the external dimension AM. In this way, by changing the external dimension AM, the fixing element 14 shown on the left can be transferred from the installed state to the mounting state and vice versa. The medium can be, for example, hydraulic oil, water, or even air. The medium can be removed from and filled into the variable-size chamber via a hand pump or an automatic, motor-driven mechanism. As an alternative to the variable-size chamber fillable with a medium, the adjustment mechanism 14c in the interior of the left fixing element 14 can also be designed as a mechanical linear drive, which enables the external dimension AM to be adjusted.

FIG. 2 shows a schematic view of an alternative embodiment of a battery arrangement 1 according to the invention. The battery arrangement 1 shown in FIG. 2 differs from the battery arrangement in FIG. 1 due to the embodiment of the two fixing elements 14. The components body support 11, battery 13, and receiving space 12 as well as the distances A are identical to the embodiment shown in FIG. 1. Also in FIG. 2, the two fixing elements 14 are designed differently or are oriented differently relative to the battery 13 and a body support 11. Both fixing elements 14 shown in FIG. 2 have a rigid body element 14a abutting a body support 11, a rigid battery element 14b abutting the battery 13, and an adjustment mechanism 14c connecting these two elements. In these embodiments as well, an external dimension AM of the fixing elements 14 extending in the direction of the distance A is designed to be adjustable and variable. In the case of both fixing elements 14, both the body element 14a and the battery element 14b are designed to be wedge-shaped in some areas, wherein the wedge-shaped areas are oriented inclined to the distance A. This wedge shape can be clearly seen in the right fixing element 14, since the wedge-shaped areas are inclined to the vertical. In the left fixing element, the wedge-shaped areas are inclined to the horizontal direction of travel, which means that the wedge shape is not visible in the state shown. The two fixing elements 14 each comprise an adjustment mechanism 14c having a tension element, which connects the body element 14a and the battery element 14b to one another in a direction perpendicular to the distance A and pulls them towards one another when actuated. The tension element can, for example, be designed as a threaded bolt having a nut screwed thereon. When the adjustment mechanism 14c is actuated, the body element 14a and the battery element 14b are moved towards one another in a direction perpendicular to the distance A and this movement is translated into a movement parallel to the distance A by sliding the wedge-shaped areas on one another. As a result of this movement parallel to the distance A between the body element 14a and the battery element 14b, the external dimension AM changes and the fixing element 14 can be transferred from the mounting state to the installed state and vice versa. In the fixing element 14 shown on the left, the tension element of the adjustment mechanism 14c is oriented horizontally, parallel to the direction of travel, whereas the tension element of the adjustment mechanism 14c in the right fixing element is oriented in the vertical direction, perpendicular to the direction of travel. The adjustment mechanism 14c can be actuated by hand, for example by applying a rotational movement to a wing nut on the tension element. Alternatively, an automatically operating mechanism can also be provided, which actuates the adjustment mechanism 14c. It is possible that the body element 14a or battery element 14b is firmly connected to the body support 11 or the battery 13 and the other element is designed to be movable in relation thereto. Finally, it is also possible to arrange a wedge-shaped surface on a body support 11 or on the battery 13. In this case, the fixing element 14 can be of a simplified design and only comprise a wedge-shaped element 14a or 14b and an adjustment mechanism 14c. In the embodiment shown in FIG. 2 as well, two identically designed or oriented fixing elements 14 are preferably used to fill the distances A in the installed state.

### LIST OF REFERENCE SIGNS

1 battery arrangement
11 body support
12 receiving space
13 battery
14 fixing element
14a body element
14b battery element
14c adjustment mechanism
A distance
AM external dimension
F vehicle

1. A battery arrangement in a vehicle, comprising:
at least two body supports of the vehicle, between which there is a receiving space,
at least one battery which is arranged at least in some areas in the receiving space between the body supports, wherein at least on one side of the battery there is a distance between a body support and a boundary surface of the battery,
at least one fixing element, which bridges or fills the distance in an installed state and is transferable to a mounting state in which the fixing element does not bridge or fill or only partially bridges or fills the distance,
wherein the fixing element is designed to be rigid at least in some areas.

2. The battery arrangement according to claim 1, in which the body supports extend essentially in the direction of travel of the vehicle, in particular are designed as rocker panels, and the distance is located in a direction perpendicular to the direction of travel of the vehicle in the receiving space between a body support and the battery, wherein at least a portion of the distance remains in the mounting state of the fixing element in order to enable mounting or dismounting of the battery in the receiving space.

3. The battery arrangement according to claim 1, in which the fixing element is designed to be completely rigid and is movably connected to a body support, wherein the fixing element bridges the distance in the installed state and abuts the battery or is connected in a form-fitting manner to a portion of the battery and in the mounting state the fixing element is separated from the battery.

4. The battery arrangement according to claim 3, in which the fixing element is fastened to the fixing element in a rotatable and/or linearly displaceable manner and is transferable from the installed state to the mounting state and vice versa by a rotational movement and/or a translational movement.

5. The battery arrangement according to claim 1, in which the fixing element comprises a body element which abuts the body support in the installed state and a battery element which abuts the battery, wherein the body element and the battery element are each designed to be rigid at least in some areas, wherein the relative position of the battery element to the body element and thus an external dimension of the fixing element extending in the installed state between the body support and the battery is adjustable via an adjustment mechanism which connects the battery element to the body element, wherein the fixing element is arranged at least in some areas in the receiving space in the installed state and fills the distance and does not fill or only partially fills the distance in the mounting state and the external dimension essentially corresponds to the distance in the installed state and is less than the distance in the mounting state.

6. The battery arrangement according to claim 5, in which the body element and the battery element are each wedge-shaped in some areas, wherein the wedge-shaped areas are oriented inclined to the distance and the adjustment mechanism has a tension element acting perpendicular to the distance, which pulls the body element and the battery element toward one another in a direction perpendicular to the distance when actuated and when the tension element is actuated, the wedge-shaped areas of the body element and battery element slide on one another and thereby translate the relative movement of the body element and battery element perpendicular to the distance towards one another into a relative movement of the body element and battery element in the direction of the distance away from one another, and enlarge the external dimension.

7. The battery arrangement according to claim 5, in which the body element and the battery element are arranged adjacent to one another in some areas in the direction of the distance, wherein the adjustment mechanism comprises a variable-size chamber arranged between the body element and the battery element, which is fillable with a medium and an enlargement of the chamber by filling with the medium causes an enlargement of the external dimension in that the chamber pushes the body element and the battery element apart in the direction of the distance, and in the installed state there is more medium in the chamber than in the mounting state.

8. The battery arrangement according to claim 5, in which the body element and the battery element are arranged adjacent to one another in some areas in the direction of the distance, wherein the adjustment mechanism comprises a linear drive arranged between the body element and the battery element, and an actuation of the linear drive changes the relative position of the body element and the battery element to one another and thus the external dimension, wherein the linear drive comprises an electric motor or a manually operable drive.

9. A vehicle having a battery arrangement according to claim 1, wherein the distance between at least one body support and the battery is preferably oriented perpendicular to the direction of travel of the vehicle.

10. A method for mounting a battery in a vehicle, wherein a battery arrangement according to claim 1 is used to carry out the method, comprising the following method steps:
A) transferring the at least one fixing element into the mounting state,
B) introducing the battery into the receiving space between two body supports of the vehicle, wherein the distance between the battery and at least one body support is used as clearance during the introduction,
C) transferring the fixing element into the installed state, in which the fixing element bridges or fills the distance, by which the battery is fixed in the receiving space in a form-fitting and/or force-fitting manner between the body supports.

11. The battery arrangement according to claim 2, in which the fixing element is designed to be completely rigid and is movably connected to a body support, wherein the fixing element bridges the distance in the installed state and abuts the battery or is connected in a form-fitting manner to a portion of the battery and in the mounting state the fixing element is separated from the battery.

12. The battery arrangement according to claim 2, in which the fixing element comprises a body element which abuts the body support in the installed state and a battery element which abuts the battery, wherein the body element and the battery element are each designed to be rigid at least in some areas, wherein the relative position of the battery element to the body element and thus an external dimension of the fixing element extending in the installed state between the body support and the battery is adjustable via an adjustment mechanism which connects the battery element to the body element, wherein the fixing element is arranged at least in some areas in the receiving space in the installed state and fills the distance and does not fill or only partially fills the distance in the mounting state and the external dimension essentially corresponds to the distance in the installed state and is less than the distance in the mounting state.
